(19) United States
(12) Patent Application Publication
(10) Pub. No.: US 2008/0013794 A1
(43) Pub. Date: Jan. 17, 2008

(54) Feature Extraction Algorithm for Automatic Ear Recognition

(75) Inventors: Antonius Adrianus Cornelis Maria Kalker, Mountain View, CA (US); Antonius Hermanus Maria Akkermans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,759

(22) PCT Filed: Sep. 6, 2005
(86) PCT No.: PCT/IB05/52905

§ 371 Date: Mar. 6, 2007

(30) Foreign Application Priority Data
Sep. 8, 2004 (EP) 04104332.4

(51) Int. Cl. G06K 9/00

(52) U.S. Cl. 382/115

(57) ABSTRACT

The present invention relates to a method and a system of recognizing an ear by locating an invariant point in a representation X of ear geometry. An idea of the present invention is the improve the well known Iannarelli algorithm in that the scheme of the present invention captures and processes all pixels values along an axis and may use an arbitrary number of axes to combine these pixel values to a complete feature vector with a sufficient level of discrimination. The prior art Iannarelli method is improved by performing a Fourier transformation of a polar representation e[θ, p] of the ear, whereby a transformed E[Θ/P] polar representation is created. This transformed representation is sampled to create an ear feature vector X_{F}.

The present invention relates to a method and a system of recognizing an ear by locating an invariant point in a representation of ear geometry.

Authentication of physical objects may be used in many applications, such as conditional access to secure buildings or conditional access to digital data (e.g. stored in a computer or removable storage media), or for identification purposes (e.g. for charging an identified individual for a particular activity).

The use of biometrics for identification and/or authentication is to an ever increasing extent considered to be a better alternative to traditional identification means such as passwords and pin-codes. The number of systems that require identification in the form of passwords/pin-codes is steadily increasing and, consequently, so is the number of passwords/pin-codes which a user of the systems must memorize. As a further consequence, due to the difficulty in memorizing the passwords/pin-codes, the user writes them down, which makes them vulnerable to theft. Hence, a more preferable solution to this problem is the use of biometric identification, wherein features that are unique to a user such as fingerprints, irises, facial properties, speech, etc. are used to provide identification of the user. In short, the user offers her biometric template to an authentication system, in which a reference template previously has been enrolled. If there is a match between the offered template and the enrolled template, i.e. the offered template is considered to resemble the enrolled template to a sufficient degree, the user is authenticated. Clearly, the user does not lose or forget his/her biometric features, neither is there any need to write them down or memorize them. Since each of these features has its advantages and disadvantages, other types of physical features are under investigation. In this respect, the shape of a human ear is well suited for deriving biometric data as it differs substantially among individuals. Is in the case with face recognition, a simple and low-cost photo camera or web-cam can be used to measure ear biometrics.

A prior art algorithm employed to characterize the shape of a human ear is the Iannarelli algorithm, which determines the distances for a small number of ear features to the center of the ear along radial axes originating from said center. Typically, four axes are used extending in eight different directions and 2-4 features (i.e. 2-4 pixel values) are used for each axis to determine to shape of the ear. However, there are some problems involved in using the Iannarelli algorithm; for example, varying lighting conditions or shades of the measured ear cause measured positions of anthropometric ear minutiae to shift. There are also problems involved in terms of variable orientation and scales.

An object of the present invention is to provide a measurement scheme in which the overall shape of the ear is taken into consideration rather than the exact locations of ear minutiae, which improves biometric template matching under different lighting conditions.

This object is attained by a method of recognizing an ear by locating an invariant point in a representation of ear geometry, in accordance with claim 1 and a system for recognizing an ear by locating an invariant point in a representation of ear geometry, in accordance with claim 9.

According to a first aspect of the invention, there is provided a method comprising the steps of creating a polar representation of the ear geometry, transforming the polar representation by means of a Fourier transformation, wherein a transformed polar representation is created, and sampling the transformed polar representation using a number of samples to create a feature vector comprising a number of feature components.

According to a second aspect of the invention, there is provided means for creating a polar representation of the ear geometry, transforming the polar representation by means of a Fourier transformation, wherein a transformed polar representation is created, and sampling the transformed polar representation using a number of samples to create a feature vector comprising a number of feature components.

An idea of the present invention is to improve the well known Iannarelli algorithm in that the scheme of the present invention captures and processes all pixels values along an axis and may use an arbitrary number of axes to combine these pixel values to a complete feature vector with a sufficient level of discrimination. First, a biometric template X of an individual is measured from a representation (e.g. a photo) of the individual's ear geometry. Thereafter, an invariant point in the representation of the ear geometry is found by studying the biometric template X. This generally implies that the center of the ear that is to be recognized is located. Second, a polar representation e[θ, ρ] of the ear is created, where θ represents the radial angle with respect to the center, and ρ the distance from the center. The prior art Iannarelli method is improved by performing a Fourier transformation of the polar representation, whereby a transformed E[Θ, P] polar representation is created. By calculating an absolute value of the transformation along θ, the representation X of the ear becomes invariant to rotations. Moreover, by calculating an absolute value of the transformation along θ, the representation of the ear becomes invariant to scaling. These combinations of transforms are generally referred to as a Fourier-Mellin Transform (FMT). A basic requirement to be satisfied for an FMT to be useful in practice is that the center of the ear can be reliably located.

Relevant information that is employed to discriminate features of the ear is obtained by capturing pixel values along the axes defined by θ and ρ. Hence, the transformed E[Θ, P] polar representation is sampled using a number n of samples to create an ear feature vector X_{F} comprising a number m of feature components. In practice, it is often the case that n=m, but it is possible that samples are discarded in the creation of the feature vectors, such that m<n. Feature vectors are created from the pixel values located along the axes, and for two different ear representations (i.e. biometric templates) X, Y, a first feature vector X_{F} of the first ear representation X will resemble a corresponding first feature vector Y_{F} of the second ear representation Y, if the angular difference θ_{X}−θ_{Y} of the axes along which the features are located is small.

The present invention is advantageous, primarily because of the fact that an ear representation X becomes invariant to rotation and scaling as mentioned above, but also because using only a few axes (as compared to the eight axes that are typically used in the Iannarelli method) will result in sufficient discrimination, while using a rather low number in of feature components. This will lead to an ear recognition scheme that is efficient in terms of processing power and robust against rotation and scaling errors.

According to an embodiment of the present invention, a distance d_{X,Y} between a first X_{F} and a second Y_{F} feature vector is determined, wherein correspondence exists between the two feature vectors (i.e. the vectors match each other) if said distance complies with a predetermined distance value, typically being a threshold value T that the distance may not exceed.

According to another embodiment of the invention, the distance d_{X,Y} between X and Y is chosen to be the Euclidian distance between the corresponding transformed polar representations E_{X}[Θ, P] and E_{Y}[Θ, P], respectively. Consequently:

$${d}_{X , Y}^{2} = {\int }_{- ∞}^{∞} {( {E}_{X} ( Θ , P ) - {E}_{Y} ( Θ , P ) )}^{2} ⅆ Θ . \qquad ( 1 )$$

For an example in which three feature vectors are compared having the values X_{F}={0}, Y_{F1}={1} and Y_{F2}={2}, it is clear that d_{X,YF1}<d_{X,YF2}. Assuming that a threshold value of T=1.5 is set, then Y_{F1} is considered to comply with X_{F} since d_{X,YF1}=1, while Y_{F2} is considered not to comply with X_{F} since d_{X,YF2}=2. In the case the scheme is applied in a biometric authentication system, the individual associated with Y_{F1} is authenticated, while authentication for the individual associated with Y_{F2} fails.

According to further embodiments of the invention, the invariant point, i.e. the center, of the ear is found by correlating the representation of ear geometry with a predetermined representation of a typical ear. A representation of a typical ear may be found by studying a number of ears and creating an “average” representation of an ear. The correlation may be undertaken by studying only a center part of the predetermined representation of a typical ear.

Further features of, and advantages with, the present invention will become apparent when studying the appended claims and the following description. Those skilled in the art realize that different features of the present invention can be combined to create embodiments other than those described in the following.

A detailed description of preferred embodiments of the present invention will be given in the following with reference made to the accompanying drawings, in which:

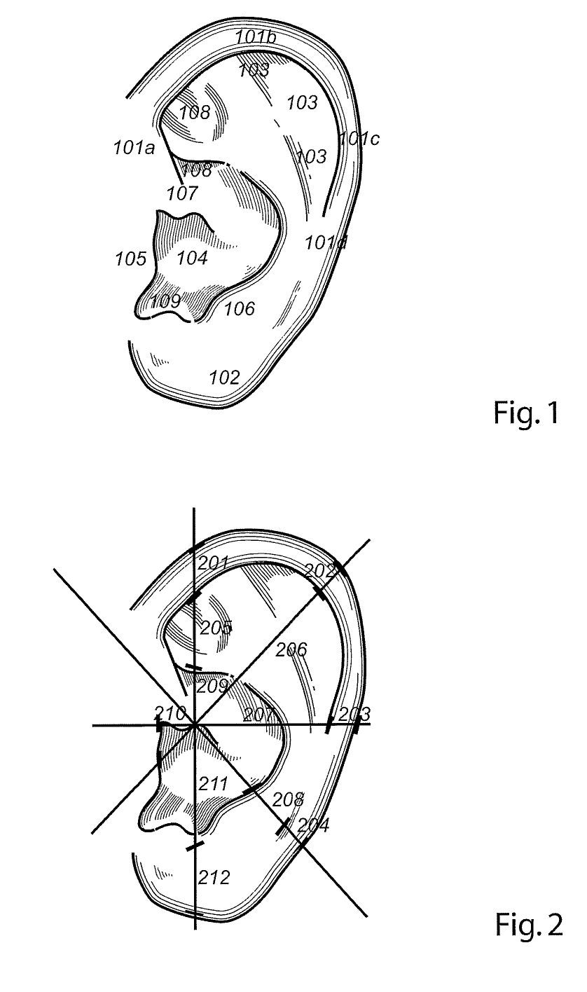

FIG. 1 shows the anatomy of a human ear;

FIG. 2 shows partitioning of a human ear in accordance with the Iannarelli method for ear recognition; and

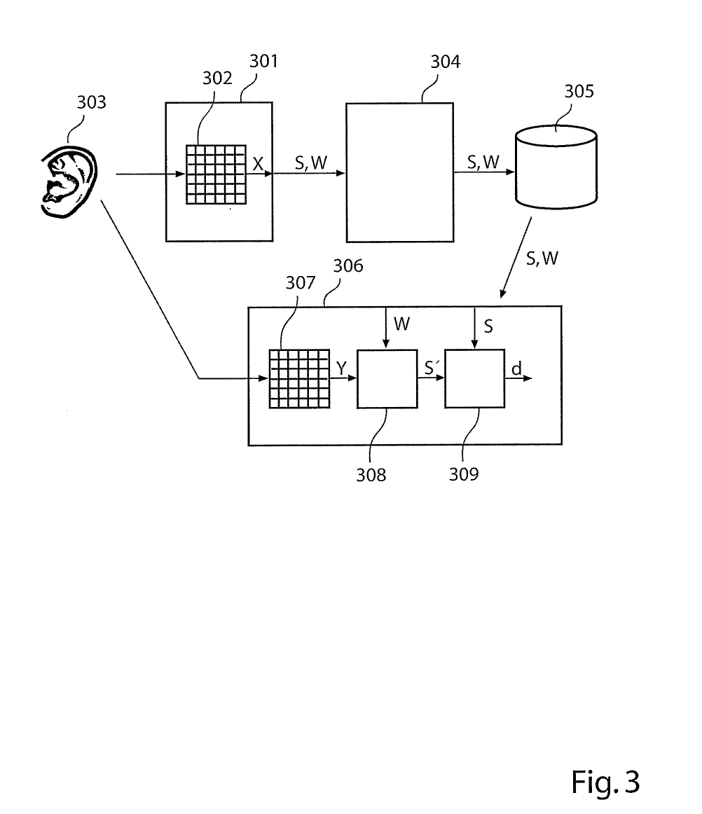

FIG. 3 shows a prior art system for verification of an individual's identity (i.e. authentication/identification of the individual) using biometric data associated with the individual, in which system the present invention advantageously can be applied.

FIG. 1 shows the anatomy of a human ear, wherein 101 denotes the helix rim, 102 the lobule, 103 the antihelix, etc.

FIG. 2 shows partitioning of a human ear in accordance with the Iannarelli method for ear recognition. The numerals indicate locations of anthropometric measurements used in the method. Typically, four axes are used extending in eight different directions and 2-4 features (i.e. 2-4 pixel values) are used for each axis to determine to shape of the ear. For example, for the axis running in the east-west direction, three measurements are made.

FIG. 3 shows a prior art system for verification of an individual's identity (i.e. authentication/identification of the individual) using biometric data associated with the individual. The system comprises a user device 301 arranged with a sensor 302 for deriving a first biometric template X from a configuration of a specific physical feature 303 (in this case an ear) of the individual. The user device employs a helper data scheme (HDS) in the verification, and enrolment data S and helper data W are derived from a first feature vector X_{F}, which feature vector typically is created by sampling the first biometric template X to create a digital set of data that subsequently can by computer processed. The user device must be secure, tamper-proof and hence trusted by the individual, such that privacy of the individual's biometric data is provided. The helper data W is typically calculated at the user device 301 such that S=G(X_{F}, W), where G is a delta-contracting function. Hence, W and S are calculated from the first feature vector X_{F} using a function or algorithm F_{G} such that (W, S)=F_{G}(X_{F}). The feature vector X_{F} is typically a vector with a predetermined number of entries.

An enrolment authority 304 initially enrolls the individual in the system by storing the enrolment data S and the helper data W received from the user device 301 in a central storage unit 305, which enrolment data subsequently is used by a verifier 306. The enrolment data S is secret to avoid identity-revealing attacks by analysis of S. At the time of verification, a second biometric template Y, which typically is a noise-contaminated copy of the first biometric template X, is offered by the individual 303 to the verifier 306 via a sensor 307. From the second biometric template Y, a second feature vector Y_{F} is derived, which typically comprises the same number of entries as the first feature vector X_{F}. The verifier 306 generates secret verification data S′ based on the second feature vector Y_{F} and the helper data W received from the central storage 305. The verifier 306 authenticates or identifies the individual by means of the enrolment data S fetched from the central storage 305 and the verification data S′ created at a crypto block 308. Noise-robustness is provided by calculating verification data S′ at the verifier as S′=G(Y_{F}, W). The delta-contracting function has the characteristic that it allows the choice of an appropriate value of the helper data W such that S′=S, if the second biometric feature vector Y_{F} sufficiently resembles the first biometric feature vector X_{F}. Hence, if a matching block 309 considers S′ to be equal to S, verification is successful.

In a practical situation, the enrolment authority may coincide with the verifier, but they may also be distributed. As an example, if the biometric system is used for banking applications, all larger offices of the bank will be allowed to enroll new individuals into the system, such that a distributed enrolment authority is created. If, after enrollment, the individual wishes to withdraw money from such an office while using her biometric data as authentication, this office will assume the role of verifier. On the other hand, if the user makes a payment in a convenience store using her biometric data as authentication, the store will assume the role of the verifier, but it is highly unlikely that the store ever will act as enrolment authority. In this sense, we will use the enrolment authority and the verifier as non-limiting abstract roles.

As can be seen hereinabove, the individual has access to a device that contains a biometric sensor and has computing capabilities. In practice, the device could comprise a camera for ear recognition in a mobile phone or a PDA. It is assumed that the individual has obtained the device from a trusted authority (e.g. a bank, a national authority, a government) and that she therefore trusts this device.

Now, when the present invention is applied in the system of FIG. 3, a biometric template X of an individual is measured from a representation (e.g. a photo) of the individual's ear geometry 303 acquired by a sensing device 301. An invariant point in the representation of the ear geometry is found at the user device 301 by studying the biometric template X. Thereafter, a polar representation e_{X}[θ, ρ] of the ear is created, where θ represents the radial angle with respect to the center, and ρ the distance from the center. With reference made to FIG. 2, the first location 206 along the axis extending in the southwest-northeast direction has an angle of 45° and a particular distance (not indicated) from origo of the depicted coordinate system (i.e. from the center of the ear).

The polar representation e_{X}[θ, ρ] of the ear geometry 303 is Fourier transformed, creating a transformed E_{X}[Θ, P] polar representation. By calculating an absolute value of the transformation with respect to the radial angle θ, the representation X of the ear becomes invariant to rotations. In addition, by calculating an absolute value of the transformation along ρ, the representation of the ear becomes invariant to scaling. This is typically referred to as a Fourier-Mellin Transform (FMT). Thus, a transformed E_{X}[Θ, P] polar representation of the biometric template X of the individual is obtained. The transformed polar representation is then sampled in the user device 301 using a number of samples n to create a first feature vector X_{F} comprising a number m of feature components.

Thereafter, at the user device 301, the helper data W is typically calculated such that S=G(X_{F}, W), where G is a delta-contracting function. Hence, W and S are calculated from the feature vector X_{F}, which vector is created from the transformed E_{X}[Θ,P] polar representation, by using a function or algorithm F_{G} such that (W, S)=F_{G}(X_{F}). As mentioned hereinabove, W and S are stored at the central storage 305 via the enrolment authority 304. At the time of verification, a second biometric template Y is offered by the individual (which template Y is derived from the geometry of the individual's ear 303) to the verifier 306 via the sensor 307. An invariant point is found at the verifier 306 by studying the second biometric template Y, a polar representation e_{Y}[θ, ρ] of the ear is created, and the polar representation e_{Y}[θ, ρ] is Fourier transformed, resulting in a transformed E_{Y}[Θ, P] polar representation. Again, a Fourier-Mellin Transform is utilized by calculating an absolute value of the transformation with respect to the radial angle θ, and an absolute value of the transformation along p. The transformed E_{Y}[Θ, P] polar representation is then sampled at the verifier 306 using a number of samples n to create a second feature vector Y_{F} comprising a number m of feature components. The verifier 306 generates secret verification data S′ based on the second feature vector Y_{F} and the helper data W received from the central storage 305, and authenticates or identifies the individual by means of the enrolment data S fetched from the central storage 305 and the verification data S′ created at the crypto block 308. Noise-robustness is provided by calculating verification data S′ at the verifier as S′=G(Y_{F}, W).

As previously discussed, the delta-contracting property of G is useful if the feature vectors X_{F} and Y_{F} are sufficiently similar as a result of the biometric templates X and Y being sufficiently similar. As previously mentioned, the feature vectors X_{F} and Y_{F} are created from the pixel values located along the axes, and for two different ear representations (i.e. biometric templates) X, Y, the feature vector X_{F} corresponding to the first ear representation X will resemble the feature vector Y_{F} of the second ear representation Y, if the angular difference θ_{X}−θ_{Y} of the axes, along which the features are located, is small. Thus, an inherent property of the delta-contracting function is that, if the matching block 309 considers S′ to match S, which indirectly implies that the angular difference is small and that the ear representations consequently resemble each other, the verification is successful. The similarity between X_{F} and Y_{F} can be expressed as, for example, the Euclidian distance between Y_{F} and X_{F} as given in (1). If the Euclidian distance between Y_{F} and X_{F} is small enough, the verification is successful.

The system for authentication/identification of the individual using biometric data associated with the individual as described above may alternatively be designed such that the user device 301 performs the operation of comparing S′ to S, in which case it may be necessary for the verifier 306 or the enrolment authority 304 to provide the user device 301 with the centrally stored helper data W.

It is clear that the devices comprised in the system of the invention, i.e. the user device, the enrolment authority, the verifier and possibly also the central storage, is arranged with microprocessors or other similar electronic equipment having computing capabilities, for example programmable logic devices such as ASICs, FPGAs, CPLDs etc. Further, the microprocessors execute appropriate software stored in memories, on discs or on other suitable media for accomplishing tasks of the present invention.

Further, it is obvious to a skilled person that the data and the communications in the system described above can be further protected using standard cryptographic techniques such as SHA-1, MD5, AES, DES or RSA. Before any data is exchanged between devices (during enrolment as well as during verification) comprised in the system, a device might want some proof on the authenticity of another other device with which communication is established. For example, it is possible that the enrolment authority must be ensured that a trusted device did generate the enrolment data received. This can be achieved by using public key certificates or, depending on the actual setting, symmetric key techniques. Moreover, it is possible that the enrolment authority must be ensured that the user device can be trusted and that it has not been tampered with. Therefore, in many cases, the user device will contain mechanisms that allow the enrolment authority to detect tampering. For example, Physical Uncloneable Functions (PUFs) may be implemented in the system. A PUF is a function that is realized by a physical system, such that the function is easy to evaluate but the physical system is hard to characterize. Depending on the actual setting, communications between devices might have to be secret and authentic. Standard cryptographic techniques that can be used are Secure Authenticated Channels (SACs) based on public key techniques or similar symmetric techniques.

Also note that the enrolment data and the verification data may be cryptographically concealed by means of employing a one-way hash function, or any other appropriate cryptographic function that conceals the enrolment data and verification in a manner such that it is computationally infeasible to create a plain text copy of the enrolment/verification data from the cryptographically concealed copy of the enrolment/verification data. It is, for example possible to use a keyed one-way hash function, a trapdoor hash function, an asymmetric encryption function or even a symmetric encryption function. In the description above, the present invention has been implemented in an exemplifying prior art system for identifying an individual using biometric data, in which system privacy of biometric templates has been provided. It should be clearly understood that the present invention also may be applied in a low-security biometric system for identification of an individual, in which system privacy is not an issue and in which system helper data is not used.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method of recognizing an ear by locating an invariant point in a representation (X) of ear geometry, the method comprising the steps of:
creating a polar representation (e[θ, ρ]) of the ear geometry;
transforming the polar representation by means of a Fourier transformation, wherein a transformed (E[Θ, P]) polar representation is created; and
sampling the transformed polar representation using a number of samples (n) to create a feature vector (X_{F}) comprising a number (m) of feature components.

2. The method according to claim 1, wherein the Fourier transform is a Fourier-Mellin Transform.

3. The method according to claim 1, wherein said invariant point in a representation (X) of the ear geometry is the center of the ear.

4. The method according to claim 1, further comprising the step of determining a distance (d) between a first (X_{F}) and a second (Y_{F}) feature vector, wherein correspondence exists between the first and the second feature vector if said distance complies with a predetermined distance value.

5. The method according to claim 4, wherein the determined distance (d) is compared to a predetermined threshold value (T), wherein the first feature vector (X_{F}) is considered to match the second feature vector (Y_{F}) if the value of said determined distance is less than said threshold value.

6. The method according to claim 4, wherein the determined distance between the first (X_{F}) and the second feature vector (Y_{F}) is the Euclidian distance.

7. The method according to claim 1, wherein the step of locating an invariant point in a representation (X) of ear geometry comprises the step of correlating the representation of ear geometry with a predetermined representation of a typical ear.

8. The method according to claim 7, wherein the step of locating an invariant point in a representation (X) of ear geometry comprises the step of correlating the representation of ear geometry with a center part of the predetermined representation of a typical ear.

9. A system for recognizing an ear by locating an invariant point in a representation (X) of ear geometry, the system comprising means (301) for creating a polar representation (e[θ, ρ]) of the ear geometry, transforming the polar representation by means of a Fourier transformation, wherein a transformed (E[Θ, P]) polar representation is created, and sampling the transformed polar representation using a number of samples (n) to create a feature vector (X_{F}) comprising a number (m) of feature components.

10. The system according to claim 9, wherein the Fourier transform is a Fourier-Mellin Transform.

11. The system according to claim 9, wherein said invariant point in a representation (X) of the ear geometry is the center of the ear.

12. The system according to claim 9, further comprising means (301, 306) for determining a distance (d) between a first (X_{F}) and a second (Y_{F}) feature vector, wherein correspondence exists between the first and the second feature vector if said distance complies with a predetermined distance value.

13. The system according to claim 12, wherein the determining means (301, 306) is further arranged to compare the distance (d) to a predetermined threshold value (T), wherein the first feature vector (X_{F}) is considered to match the second feature vector (Y_{F}) if the value of said determined distance is less than said threshold value.

14. The system according to claim 12, wherein the determined distance between the first (X_{F}) and the second feature vector (Y_{F}) is the Euclidian distance.

15. The system according to claim 9, wherein the means (301) for creating a polar representation (e[θ, ρ]) of the ear geometry is further arranged to locate an invariant point in the representation (X) of ear geometry by correlating said representation of ear geometry with a predetermined representation of a typical ear.

16. The system according to claim 15, wherein the means (301) for creating a polar representation (e[θ, ρ]) of the ear geometry is further arranged to correlate the representation (X) of ear geometry with a center part of the predetermined representation of a typical ear.

17. A computer program product comprising executable components for causing a device having computing capabilities to perform the steps recited in claim 8 when the components are executed in said device having computing capabilities.
